(19) United States
(12) Patent Application Publication
(10) Pub. No.: US 2025/0330624 A1
(43) Pub. Date: Oct. 23, 2025

(54) PLENO-GENERATION FACE VIDEO COMPRESSION FRAMEWORK FOR GENERATIVE FACE VIDEO COMPRESSION

(71) Applicant: Alibaba (China) Co., Ltd., Hangzhou (CN)

(72) Inventors: Bolin Chen, Hong Kong (CN); Yan Ye, San Diego, CA (US); Jie Chen, Beijing (CN); Ru-Ling Liao, Sunnyvale, CA (US); Shiqi Wang, Hong Kong (CN)

(21) Appl. No.: 19/096,523

(22) Filed: Mar. 31, 2025

Related U.S. Application Data
(60) Provisional application No. 63/631,987, filed on Apr. 9, 2024.

(51) Int. Cl. H04N 19/33; G06V 10/77; G06V 40/16; H04N 19/13; H04N 19/137; H04N 19/172; H04N 19/42

(52) U.S. Cl. CPC H04N 19/33; G06V 10/7715; G06V 40/168; H04N 19/13; H04N 19/137; H04N 19/172; H04N 19/42

(57) ABSTRACT

Methods and systems implement a pleno-generation face video compression framework with bandwidth intelligence for generative models and compression. Heterogeneous-granularity facial description regularizes long-term dependencies between video frames and compensates for motion estimation errors caused by compact representations of motion information. A generative decoder reconstructs heterogeneous-granularity visual representations, providing auxiliary visual signals for attention-based recalibration of a GFVC-reconstructed face signal. A coarse-to-fine generation strategy avoids error accumulation. High efficiency for heterogeneous-granularity signal compression is achieved by two different entropy-based signal compression methods: heterogeneous-granularities feature representation from the key-reference frame as hyperpriors to optimize the entropy model for compressing heterogeneous-granularity feature from subsequent inter frames, and a feature difference operation for heterogeneous-granularities feature representation between key-reference and subsequent inter frames, such that the entropy model only compresses heterogeneous-granularities feature residual for redundancy reduction. Mixed-model dataset generation and training and model-specific dataset generation and training are also provided.

### PRIORITY

This application claims priority from U.S. Provisional Patent Application No. 63/631,987, filed on Apr. 9, 2024, entitled “PLENO-GENERATION FACE VIDEO COMPRESSION FRAMEWORK FOR GENERATIVE FACE VIDEO COMPRESSION,” and is fully incorporated by reference herein.

### BACKGROUND

Techniques for compression of video data have grown to include generative representation powered by Artificial Intelligence Generated Content (“AIGC”) models, with the aim of substantially improving bitrate transmission efficiency over signal-level coding. For decades, face video coding technologies in particular have been hindered by subpar face analysis and synthesis. More recently, deep generative models have yielded learning-based face reenactment and animation models embodied by Generative Face Video Compression (“GFVC”), wherein encoder architecture employs an analysis model to effectively characterize complex facial motions, while decoder architecture utilizes a synthesis model to reconstruct high-quality face video. Pixel-level facial signal can be economically represented into compact representations, such as 2D landmarks, 2D keypoints, 3D keypoints, temporal trajectory feature, segmentation map and facial semantics. Such implementations aim to enable transmission of face-to-face video communications under ultra-low bitrates.

However, in general, generative models focus on generating visually rich textures given features, while compression, in contrast, aims to reconstruct a given video with the allocated bitrate. While generative models prioritize the quality of the generated content, compression techniques prioritize efficient representation and reconstruction of the original video within the available bitrate. Therefore, in the context of learning-based compression, the inference process inherently incorporates the ground-truth video content in encoding. There remains substantial room to design innovative and tailored generative techniques specifically for compression.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example block diagram of an encoding process according to an example embodiment of the present disclosure.

FIG. 2 illustrates an end-to-end video compression deep learning model that jointly optimizes components for video compression.

FIG. 3 illustrates a flowchart of a deep learning model-based video generative compression First Order Motion Model.

FIG. 4 illustrates a flowchart of a deep learning model-based video generative compression model based on compact feature representations.

FIG. 5 illustrates a pleno-generation face video compression framework according to example embodiments of the present disclosure.

FIGS. 6A and 6B illustrate detailed views of the enhancement model of FIG. 5.

FIG. 7 illustrates the coarse-to-fine frame generation model of FIG. 5.

FIGS. 8A and 8B illustrate flowcharts of two different training strategies: mixed-model dataset generation and training, and model-specific dataset generation and training.

FIG. 9 illustrates an example system for implementing the processes and methods described herein for implementing a pleno-generation face video compression framework with bandwidth intelligence for generative models and compression.

### DETAILED DESCRIPTION

Systems and methods discussed herein are directed to implementing a pleno-generation face video compression framework with bandwidth intelligence for generative models and compression. A generative decoder reconstructs heterogeneous-granularity visual representations, providing auxiliary visual signals for attention-based recalibration of a GFVC-reconstructed face signal. A coarse-to-fine generation strategy avoids error accumulation. High efficiency for heterogeneous-granularity signal compression is achieved by two different entropy-based signal compression methods. Mixed-model dataset generation and training and model-specific dataset generation and training are also provided.

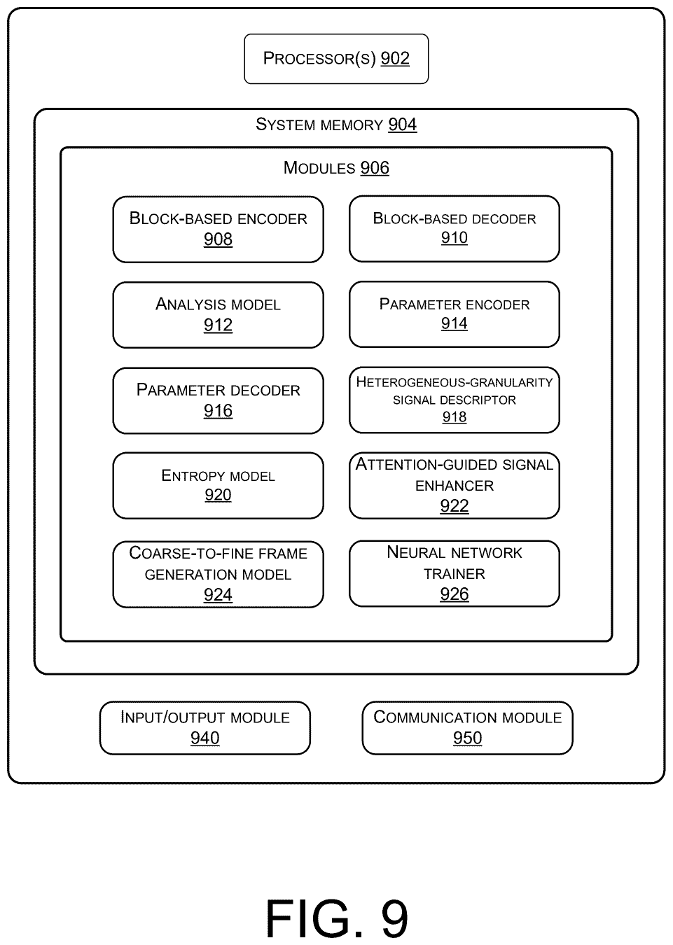

In accordance with the H.264/AVC (Advanced Video Coding), H.265/HEVC (High Efficiency Video Coding), and Versatile Video Coding (“VVC”) standards, a block-based hybrid video coding framework is implemented to exploit the spatial redundancy, temporal redundancy and information entropy redundancy in video. A computing system includes at least one or more processors and a computer-readable storage medium communicatively coupled to the one or more processors. The computer-readable storage medium is a non-transient or non-transitory computer-readable storage medium, as defined subsequently with reference to FIG. 9, storing computer-readable instructions. At least some computer-readable instructions stored on a computer-readable storage medium are executable by one or more processors of a computing system to configure the one or more processors to perform associated operations of the computer-readable instructions, including at least operations of an encoder as described by the above-mentioned standards, and operations of a decoder as described by the above-mentioned standards. Some of these encoder operations and decoder operations according to the above-mentioned standard are subsequently described in further detail, though these subsequent descriptions should not be understood as exhaustive of encoder operations and decoder operations according to the above-mentioned standards. Subsequently, a “block-based encoder” and a “block-based decoder” shall describe the respective computer-readable instructions stored on a computer-readable storage medium which configure one or more processors to perform these respective operations (which can be called, by way of example, “reference implementations” of an encoder or a decoder).

Moreover, according to example embodiments of the present disclosure, a block-based encoder and a block-based decoder further include computer-readable instructions stored on a computer-readable storage medium which are executable by one or more processors of a computing system to configure the one or more processors to perform operations not specified by the above-mentioned standards. A block-based encoder should not be understood as limited to operations of a reference implementation of an encoder, but including further computer-readable instructions configuring one or more processors of a computing system to perform further operations as described herein. A block-based decoder should not be understood as limited to operations of a reference implementation of a decoder, but including further computer-readable instructions configuring one or more processors of a computing system to perform further operations as described herein.

Example embodiments of the present disclosure can improve functioning of a computer device in a number of ways. For example, in the context of video encoding, a video can be more effectively encoded and decoded with less use of computing resources such as processing and memory. The techniques herein provide distinct improvements over standard GFVC techniques, such as coverage of a broader bitrate range rather than a particular rate point, improvements to complex motion, scenes with many long-term dependencies, improvements to missing details, and temporal consistency. Improvements on the rate distortion balance aid provide improvements to stable visual reconstruction with precise motion and vivid texture from compact feature representations. Conceptually, generative models prioritize the quality of the generated content, whilst compression techniques target optimal balances between transmission bitrate and reconstruction quality. While compression is evaluated on pixel-level or perceptual-level image quality measurement, generation is evaluated on model robustness using different benchmarks (e.g., image quality, aesthetic quality, dynamic degree, motion smoothness and subject/background consistency). These divergent evaluation dimensions may fail to align with the baseline evaluation of human visual perception. Therefore, the techniques herein enable more comprehensive benchmarks to align with human visual perception and verify model by way of enabling superior evaluation dimensions.

Additionally, the reconstruction quality of the output frames is improved by way of auxiliary facial signals. These improvements may, by way of example, include removal of occlusion artifacts, removal of low face fidelity, and improvements on local motion. In particular, motion estimation errors can be perceptually compensated and the long-term dependencies among face frames can be accurately regularized. Consequently, the improvements to reconstruction quality can even have an incline to the pixel-level construction with faithful representation of texture and motion. Furthermore, by characterizing the face data with compact feature representations and an enriched signal, conceptually-explicit visual information can be encoded into the bitstream in a manner where they can be partially transmitted and decoded. Hence, example embodiments of the present disclosure can perform reconstruction based on the bandwidth environment, maintaining coding flexibility.

Because the techniques herein enable scalability and can be considered to be separated into two layers, the second layer provides advantages in its compatibility with a variety of configurations of the first layer. This universal plug-and-play advantage increases flexibility and therefore allows the techniques herein to realize signal representation for a variety of different granularities and support different qualities of video communication according to the requirements of the bandwidth environment.

The techniques described herein can be implemented in a number of ways. Example embodiments are provided below with reference to the following figures. Although discussed in the context of facial video encoding, the methods, apparatuses, and systems described herein can be applied to a variety of systems (e.g., a body visual video, a LIDAR video, a 3-D video, a simulated video, a robot sensor), and is not limited to facial video. Additionally, the techniques described herein can be used with real data, simulated data, training data, or any combination thereof. Furthermore, the techniques described herein may be used to determine training data, used to categorize video data, used to extract information from video data, or other associated uses of video data, as examples without limitation, in a granularity and bandwidth associated manner.

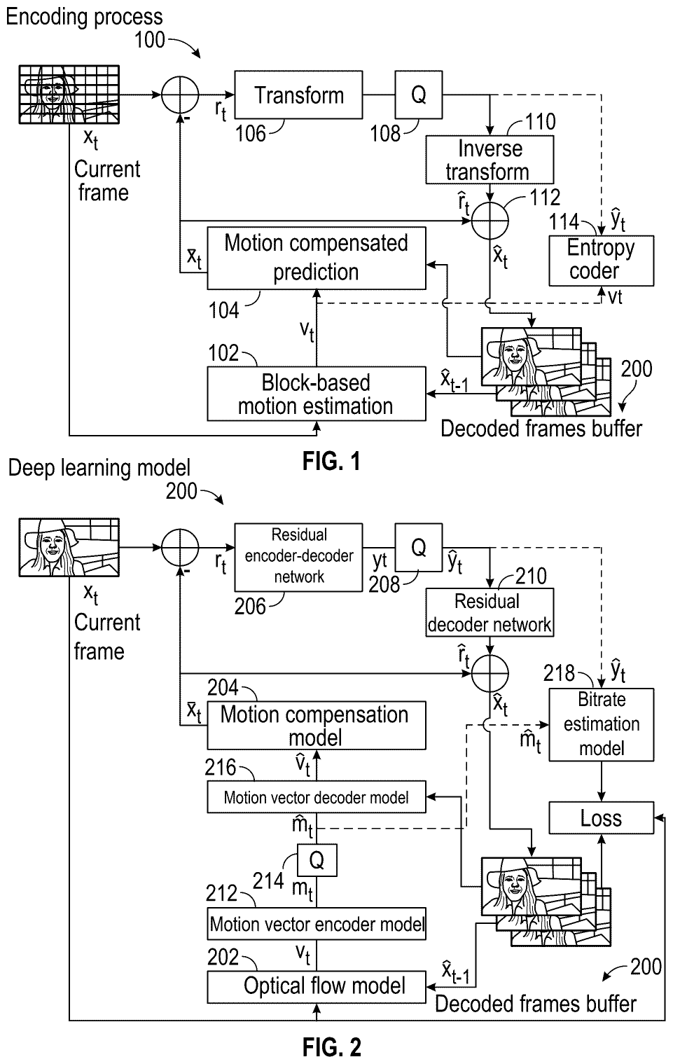

FIG. 1 illustrates an example block diagram of an encoding process 100 according to an example embodiment of the present disclosure. The encoding process 100 and a decoding process follow the predict-transform architecture, wherein the video compression encoder generates the bitstream based on the input current frames, and the decoder reconstructs the video frames based on the received bitstreams.

In an encoding process 100, a block-based encoder configures one or more processors of a computing system to receive, as input, one or more input frames from an image source. A block-based encoder encodes a frame (a frame being encoded being called a “current frame,” as distinguished from any other frame received from an image source) by configuring one or more processors of a computing system to partition the original frame into units and subunits according to a partitioning structure. A block-based encoder configures one or more processors of a computing system to subdivide the input frame x_t is split into a set of blocks, i.e., square regions, of the same size (e.g., 8×8).

A block-based encoder configures one or more processors of a computing system to perform motion estimation 102: estimating the motion between the current frame xₜ and the previous reconstructed frame \hat{x}ₜ₋₁. The corresponding motion vector vₜ for each block is obtained.

A block-based encoder configures one or more processors of a computing system to perform motion compensated prediction 104 upon blocks of a current frame. Motion compensation causes frame data of a current frame (and blocks thereof) using motion information and prediction units (“PUs”), rather than pixel data, according to intra prediction or inter prediction. The predicted frame x̅ₜ is obtained by copying the corresponding pixels in the previous reconstructed frame to the current frame based on the motion vector vₜ obtained in step 102. The difference rₜ between the original frame xₜ and the predicted frame x̅ₜ is called the prediction residual, or “residual” for brevity, and is obtained as rₜ=xₜ−x̅ₜ.

Motion information refers to data describing motion of a block structure of a frame or a unit or subunit thereof, such as motion vectors and references to blocks of a current frame or of a reference frame. PUs may refer to a unit or multiple subunits corresponding to a block structure among multiple block structures of a frame, wherein blocks are partitioned based on the frame data and are coded according to block-based coding. Motion information corresponding to a PU may describe motion prediction as encoded by a block-based encoder as described herein.

According to intra prediction, one or more processors of a computing system are configured to encode a block by references to motion information and PUs of one or more other blocks of the same frame. According to intra prediction coding, one or more processors of a computing system perform an intra prediction (also called spatial prediction) computation by coding motion information of the current block based on spatially neighboring samples from spatially neighboring blocks of the current block.

According to inter prediction, one or more processors of a computing system are configured to encode a block by references to motion information and PUs of one or more other frames. One or more processors of a computing system are configured to store one or more previously coded and decoded frames in a reference frame buffer for the purpose of inter prediction coding; these stored frames are called reference frames.

One or more processors are configured to perform an inter prediction (also called temporal prediction or motion compensated prediction) computation by coding motion information of the current block based on samples from one or more reference frames.

Based on a prediction residual, a block-based encoder further implements a transform 106. One or more processors of a computing system are configured to perform a transform operation on the residual by a matrix arithmetic operation to compute an array of coefficients (which can be referred to as “residual coefficients,” “transform coefficients,” and the like), thereby encoding a current block as a transform block (“TB”). Transform coefficients may refer to coefficients representing one of several spatial transformations, such as a diagonal flip, a vertical flip, or a rotation, which may be applied to a sub-block.

It should be understood that a coefficient can be stored as two components, an absolute value and a sign, as shall be described in further detail subsequently.

Sub-blocks of CUs, such as PUs and TBs, can be arranged in any combination of sub-block dimensions as described above. A block-based encoder configures one or more processors of a computing system to subdivide a CU into a residual quadtree (“RQT”), a hierarchical structure of TBs. The RQT provides an order for motion prediction and residual coding over sub-blocks of each level and recursively down each level of the RQT.

A linear transform (e.g., DCT) is used before quantization for better compression performance.

A block-based encoder further implements a quantization (“Q”) 108. One or more processors of a computing system are configured to perform a quantization operation on the residual coefficients by a matrix arithmetic operation, based on a quantization matrix and the QP as assigned above. Residual coefficients falling within an interval are kept, and residual coefficients falling outside the interval step are discarded. Thus, the residual rₜ is quantized to ŷₜ.

A block-based encoder further implements an inverse transform 110. One or more processors of a computing system are configured to perform an inverse transform operation on the quantized residual coefficients, by matrix arithmetic operations which are the inverse of the quantization operation and transform operation as described above. The inverse quantization operation and the inverse transform operation yield a reconstructed residual. Thus, the quantized result ŷₜ is inverse transformed to yield the reconstructed residual \hat{r}ₜ.

A block-based encoder further implements an adder 112. One or more processors of a computing system are configured to perform an addition operation by adding a prediction block and a reconstructed residual, outputting a reconstructed block. Thus, the reconstructed frame \hat{x}ₜ is obtained by adding \hat{x}ₜ and \hat{r}ₜ, i.e. \hat{x}ₜ=\hat{r}ₜ+x̅ₜ.

A block-based encoder further configures one or more processors of a computing system to output a filtered reconstructed block to a decoded frame buffer 200. A decoded frame buffer stores reconstructed frames which are used by one or more processors of a computing system as reference frames in coding frames other than the current frame, as described above with reference to inter prediction. Thus, the reconstructed frame will be used by the (t−1)ₜₕ frame at step 102 for motion estimation.

A block-based encoder further implements an entropy coder 114. One or more processors of a computing system are configured to perform entropy coding, wherein, according to the Context-Sensitive Binary Arithmetic Codec (“CABAC”), symbols making up quantized residual coefficients are coded by mappings to binary strings (subsequently “bins”), which can be transmitted in an output bitstream at a compressed bitrate. The symbols of the quantized residual coefficients which are coded include absolute values of the residual coefficients (these absolute values being subsequently referred to as “residual coefficient levels”).

The entropy coder configures one or more processors of a computing system to code residual coefficient levels of a block; bypass coding of residual coefficient signs and record the residual coefficient signs with the coded block; record coding parameter sets such as coding mode, a mode of intra prediction or a mode of inter prediction, and motion information coded in syntax structures of a coded block (such as a picture parameter set (“PPS”) found in a picture header, as well as a sequence parameter set (“SPS”) found in a sequence of multiple pictures); and output the coded block. Thus, the motion vector vₜ and the quantized result ŷₜ are both encoded into bits by the entropy coding method and sent to a decoder.

A block-based encoder configures one or more processors of a computing system to output a coded picture, made up of coded blocks from the entropy coder 114. The coded picture is output to a transmission buffer, where it is ultimately packed into a bitstream for output from the block-based encoder. The bitstream is written by one or more processors of a computing system to a non-transient or non-transitory computer-readable storage medium of the computing system, for transmission.

In a decoding process, a block-based decoder configures one or more processors of a computing system to receive, as input, one or more coded pictures from a bitstream.

A block-based decoder implements an entropy decoder. One or more processors of a computing system are configured to perform entropy decoding, wherein, according to CABAC, bins are decoded by reversing the mappings of symbols to bins, thereby recovering the entropy-coded quantized residual coefficients. The entropy decoder outputs the quantized residual coefficients, outputs the coding-bypassed residual coefficient signs, and also outputs the syntax structures such as a PPS and a SPS.

A block-based decoder further implements an inverse quantization and an inverse transform. One or more processors of a computing system are configured to perform an inverse quantization operation and an inverse transform operation on the decoded quantized residual coefficients, by matrix arithmetic operations which are the inverse of the quantization operation and transform operation as described above. The inverse quantization operation and the inverse transform operation yield a reconstructed residual.

Furthermore, based on coding parameter sets recorded in syntax structures such as PPS and a SPS by the entropy coder (or, alternatively, received by out-of-band transmission or coded into the decoder), and a coding mode included in the coding parameter sets, the block-based decoder determines whether to apply intra prediction (i.e., spatial prediction) or to apply motion compensated prediction (i.e., temporal prediction) to the reconstructed residual.

In the event that the coding parameter sets specify intra prediction, the block-based decoder configures one or more processors of a computing system to perform intra prediction using prediction information specified in the coding parameter sets. The intra prediction thereby generates a prediction signal.

In the event that the coding parameter sets specify inter prediction, the block-based decoder configures one or more processors of a computing system to perform motion compensated prediction using a reference picture from a decoded frames buffer 200. The motion compensated prediction thereby generates a prediction signal.

A block-based decoder further implements an adder. The adder configures one or more processors of a computing system to perform an addition operation on the reconstructed residuals and the prediction signal, thereby outputting a reconstructed block.

A block-based decoder further configures one or more processors of a computing system to output a filtered reconstructed block to the decoded frame buffer 200. As described above, a decoded frame buffer 200 stores reconstructed pictures which are used by one or more processors of a computing system as reference pictures in coding pictures other than the current picture, as described above with reference to motion compensated prediction.

A block-based decoder further configures one or more processors of a computing system to output reconstructed pictures from the decoded frame buffer 200 to a user-viewable display of a computing system, such as a television display, a personal computing monitor, a smartphone display, or a tablet display.

Therefore, as illustrated by an encoding process 100 and a decoding process as described above, a block-based encoder and a block-based decoder each implements motion prediction coding in accordance with the above-mentioned standards. A block-based encoder and a block-based decoder each configures one or more processors of a computing system to generate a reconstructed picture based on a previous reconstructed picture of a decoded frame buffer 200 according to motion compensated prediction as described by the above-mentioned standards, wherein the previous reconstructed picture serves as a reference picture in motion compensated prediction as described herein.

Deep learning models have been proposed to replace or enhance individual video coding tools, including intra/inter prediction, entropy coding and in-loop filtering. Moreover, deep learning models have been proposed to provide jointly optimized end-to-end image and video compression pipelines, rather than one particular module thereof.

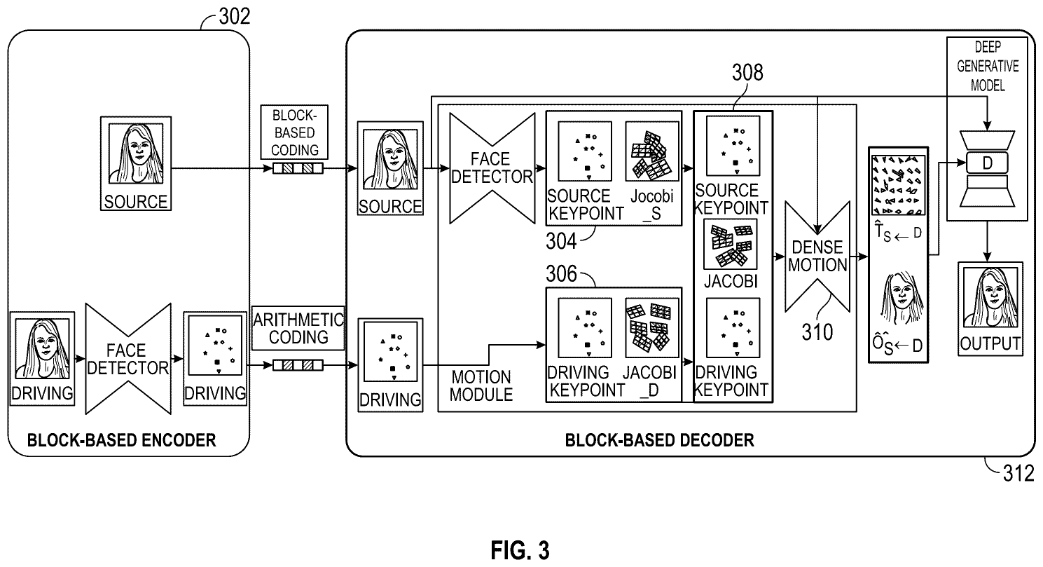

By way of example, FIG. 2 illustrates an end-to-end video compression deep learning model 200 that jointly optimizes components for video compression, such as motion estimation, motion compression, and residual compression. Learning-based optical flow estimation configures one or more processors of a computing system to obtain motion information and reconstruct the current frames. Two auto-encoder style neural networks configure one or more processors of a computing system to compress the corresponding motion and residual information. The modules are jointly learned through a single loss function, in which they collaborate by considering the trade-off between reducing the number of compression bits and improving quality of the decoded video.

A learning model can include one or more sets of computer-readable instructions executable by one or more processors of a computing system to perform tasks that include processing input and various parameters of the model, and outputting results. A learning model can be, for example, a layered model such as a deep neural network, which can have a fully-connected structure, can have a feedforward structure such as a convolutional neural network (“CNN”), can have a backpropagation structure such as a recurrent neural network (“RNN”), or can have other architectures suited to the computation of particular tasks. Generally, any layered model having multiple layers between an input layer and output layer is a deep neural network (“DNN”).

There are one-to-one correspondences between the video compression process illustrated by FIG. 1 and the end-to-end deep learning model-based process illustrated by FIG. 2. Relationships and differences are introduced as follows:

To perform motion estimation and compression, an optical flow model 202 (such as, by way of example, a CNN) configures one or more processors of a computing system to estimate the optical flow, which is considered as motion information vₜ. Instead of directly encoding the raw optical flow values, an MV encoder-decoder network configures one or more processors of a computing system to compress and decode the optical flow values, in which the quantized motion representation is denoted as \hat{m}ₜ. Then, the corresponding reconstructed motion information \hat{v}ₜ can be decoded by using the MV decoder net.

To perform motion compensation, a motion compensation model 204 configures one or more processors of a computing system to obtain the predicted frame x̅ₜ based on the optical flow yielded by the optical flow model 202.

To perform transforms, quantization and inverse transforms, rather than a linear transform, a highly non-linear residual encoder-decoder network 206 configures one or more processors of a computing system to non-linearly map the residual rₜ to the representation yₜ. Then, yₜ is quantized to ŷₜ at quantization 208. The quantized representation ŷt is input to a residual decoder network 210 to obtain a reconstructed residual \hat{r}ₜ.

To perform entropy coding, at the testing stage, a motion vector encoder model 212 configures one or more processors of a computing system to code the motion representation \hat{m}ₜ (quantized at quantization 214) and the residual representation ŷₜ into bits, and input the coded bits to a motion vector decoder model 216. At the training stage, to estimate the number of bits cost, a bitrate estimation model 218 configures one or more processors of a computing system to obtain the probability distribution of each symbol in \hat{m}ₜ and ŷₜ.

Frame reconstruction proceeds as described above with reference to FIG. 1.

Further proposals of deep generative models implement Variational Auto-Encoding (“VAE”) and Generative Adversarial Networks (“GAN”) to seek further performance improvement. “fs-vid2vid” or “FV2V” implements 3D keypoint representation driving a generative model for rendering the target frame. First Order Motion Model (“FOMM”) implements a mobile-compatible video chat system. Compact feature learning (“CFTE”) implements an end-to-end talking-head video compression framework for talking face video compression under ultra-low bandwidth. The 3D morphable model (“3DMM”) template implements facial semantics to characterize facial video and implement face manipulation for facial video coding.

Table 1 below further summarizes compact representations for generative face video compression algorithms. Face images exhibit strong statistical regularities, which can be economically characterized with 2D landmarks, 2D keypoints, region matrix, 3D keypoints, compact feature matrix and facial semantics. Such facial description strategies can lead to reduced coding bit-rate and improve coding efficiency, thus being applicable to video conferencing and live entertainment.

| Compact | |
|---|---|
| representation | Description |
| 2D landmarks | VSBNet is a representative model which can utilize 98 groups of 2D facial landmarks [symbol] ^{2×98} |
| | to depict the key structure information of human face, where the total number of encoding |
| | parameters for each inter frame is 196. |
| 2D keypoints | FOMM is a representative model which adopts 10 groups of learned 2D keypoints [symbol] ^{2×10} |
| and affine | along with their local affine transformations [symbol] ^{2×2×10} to characterize complex |
| transformation | motions. The total number of encoding parameters for each inter frame is 60. |
| matrix | |
| Region matrix | Motion representations for articulated animation (“MRAA”) is a representative model which |
| | extracts consistent regions of talking face to describe locations, shape, and pose, mainly |
| | represented with shift matrix [symbol] ^{2×10}, covar matrix [symbol] ^{2×2×10} and affine matrix [symbol] ^{2×2×10}. |
| | As such, the total number of encoding parameters for each inter frame is 100. |
| 3D keypoints | Face_vid2vid is a representative model which can estimate 12-dimension head parameters |
| | (i.e., rotation matrix [symbol] ^{3×3} and translation parameters [symbol] ^{3×1}) and 15 groups of learned 3D |
| | keypoint perturbations [symbol] ^{3×15} due to facial expressions, where the total number of encoding |
| | parameters for each inter frame is 57. |
| Compact | CFTE is a representative model which can model the temporal evolution of faces into |
| feature | learned compact feature representation with the matrix [symbol] ^{4×4}, where the total number of |
| matrix | encoding parameters for each inter frame is 16. |
| Facial | Interactive Face Video Coding (“IFVC”) is a representative model which adopts a collection |
| semantics | of transmitted facial semantics to represent the face frame, including mouth parameters [symbol] ⁶ |
| | eye parameter [symbol] ¹, rotation parameters [symbol] ³, translation parameters [symbol] ³ and location |
| | parameter [symbol] ¹. Totally, the number of encoding parameters for each inter frame is 14. |

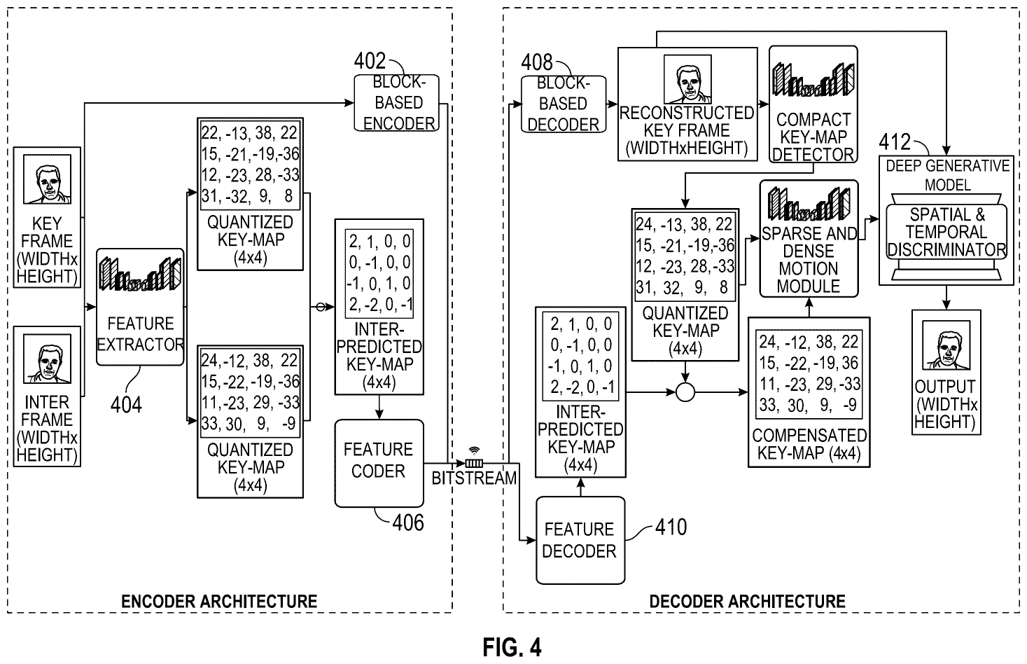

FIG. 3 illustrates a flowchart of a deep learning model-based video generative compression FOMM. An FOMM configures one or more processors of a computing system to deform a reference source frame to follow the motion of a driving video, and applies this to face videos in particular. The FOMM of FIG. 3 implements an encoder-decoder architecture with a motion transfer component.

The encoder configures one or more processors of a computing system to encode the source frame by a block-based image or video compression method, such as HEVC/VVC or JPEG/BPG. As illustrated in FIG. 3, a block-based encoder 302 as described above with reference to FIG. 1 configures one or more processors of a computing system to compress the source frame according to block-based video coding standards, such as VVC.

One or more processors of a computing system are configured to learn a keypoint extractor using an equivariant loss, without explicit labels. The keypoints (x, y) collectively represent points of a feature map having highest visual interest. A source keypoint extractor 304 and a driving keypoint extractor 306 respectively configure one or more processors of a computing system to compute two sets of ten learned keypoints for the source and driving frames. A Gaussian mapping operation 308 configures one or more processors of a computing system to transform the learned keypoints from the feature map with the size of channel×64×64. Thus, every corresponding keypoint can represent feature information of different channels.

A dense motion network 310 configures one or more processors of a computing system to, based on the learned keypoints and the source frame, output a dense motion field and an occlusion map.

A block-based decoder 312 configures one or more processors of a computing system to generate an image from the warped map.

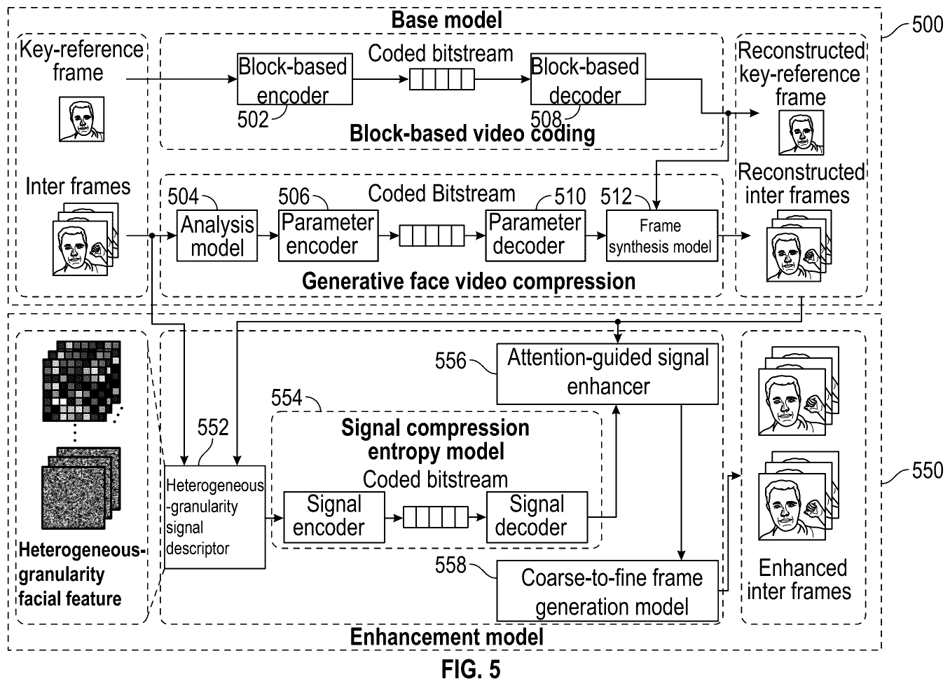

FIG. 4 illustrates a flowchart of a deep learning model-based video generative compression model based on compact feature representations, namely CFTE proposed by Chen et al., The model of FIG. 4 implements an encoder-decoder architecture which configures one or more processors of a computing system to process a sequence of frames, including a key frame and multiple subsequent inter frames.

Encoder architecture includes a block-based encoder 402, a feature extractor 404, and a feature coder 406.

A feature extractor 404 should be understood as a learning model trained to extract human features from picture data input into the learning model.

The block-based encoder 402 configures one or more processors of a computing system to compress a key frame which represents human textures according to block-based video coding standards, such as VVC as illustrated herein.

The feature extractor 404 configures one or more processors of a computing system to represent each of the subsequent inter frames with a compact feature matrix with the size of 1×4×4. The size of compact feature matrix is not fixed and the number of feature parameters can also be increased or decreased based on available bitrate for transmission.

These extracted features are inter-predicted and quantized as described above with reference to FIG. 1. The feature coder 406 configures one or more processors of a computing system to entropy code the residuals and transmit the coded residuals in a bitstream.

Decoder architecture includes a block-based decoder 408, a feature decoder 410, and a deep generative model 412

The block-based decoder 408 configures one or more processors of a computing system to output a decoded key frame from the transmitted bitstream according to block-based video coding standards, such as VVC as illustrated herein.

The feature decoder 410 configures one or more processors of a computing system to perform compact feature extraction on the decoded key frame to output features.

Subsequently, given the compact features from the key and inter frames, a relevant sparse motion field is calculated, facilitating the generation of a pixel-wise dense motion map and occlusion map.

The deep generative model 412 configures one or more processors of a computing system to output a video for display based on the decoded key frame, the pixel-wise dense motion map, and the occlusion map with implicit motion field characterization, generating appearance, pose, and expression.

Moreover, the example associated with F2V2 provides feature extraction from two sampled images of a video sequence: a source image and a driving image. Extracted features include an appearance feature and canonical keypoints. A head pose and expression deformation are estimated, and applied to the canonical keypoints to derive source keypoints and driving keypoints. By decomposing these sets of keypoints and training to minimize keypoint-based loss functions, a warping function is learned which transforms source features to synthesize a new face picture.

Lossy video compression based on Shannon's information theory aims to achieve minimal transmission bitrate (i.e., R) with the lowest possible distortion (i.e., D). Video compression can be generalized as a rate-distortion optimization to minimize overall cost J_{cost}, with a trade-off coefficient between R and D according to Equation 1 as follows,

J_{cost}=D+λR

where λ is the Lagrange multiplier representing the R-D relationship for a particular quality level. Minimal bitrate with lowest distortion may be referred to as a high rate-distortion (“RD”) performance.

Conventionally, increasing bits to represent and transmit the data is a trade-off to reduce visible distortion incurred from the compressed representation. However, this trade-off does not fully apply to existing generative compression algorithms relying on the straightforward application of generation models, such that superior RD trade-offs cannot be achieved in an overall bitrate coverage.

For generative compression algorithms, bitrate range is mainly adjusted based on compression degree and dynamic number of the key-reference frame (costed to provide vivid texture and color), while it is almost unaffected by compact representations of complex temporal motion. As a result, generative compression algorithms based on compact representation are typically forced to operate at one particular rate point. The techniques disclosed herein may be considered to accommodate a variable bitrate, as they perform at different bitrates.

Thus, in generative compression, RD balancing of the compression task becomes a constraint for the generation task. Generative compression of scenes including complex motion and long-term dependencies is prone to yield artifacts, missing details and temporal inconsistency, so generating stable visual reconstruction, with precise motion and vivid texture, from compact feature representations remains a challenge.

Additionally generative models and compression are optimized to achieve different targets: although the performance of both is evaluated based on human perception of generated and reconstructed videos, compression tasks are evaluated based on pixel-level or perceptual-level image quality measurement, while generation tasks are evaluated based on image quality, aesthetic quality, dynamic degree, motion smoothness and subject-to-background consistency, to reflect model robustness. There is a lack of comprehensive benchmarks which both align with human perception and verify model robustness.

Therefore, according to example embodiments of the present disclosure, to overcome poor long-term dependencies and inaccurate motion estimation caused by the compact representations of GFVC algorithms, a pleno-generation face video compression framework with bandwidth intelligence for generative models and compression is implemented by the techniques and embodiments herein to deliver an auxiliary facial signal to describe important motion information (e.g., expression and headpose) and complex background changes in a scalable and flexible manner. Signals can be well-characterized at different granularity levels suited to different bitstream bandwidth limitations.

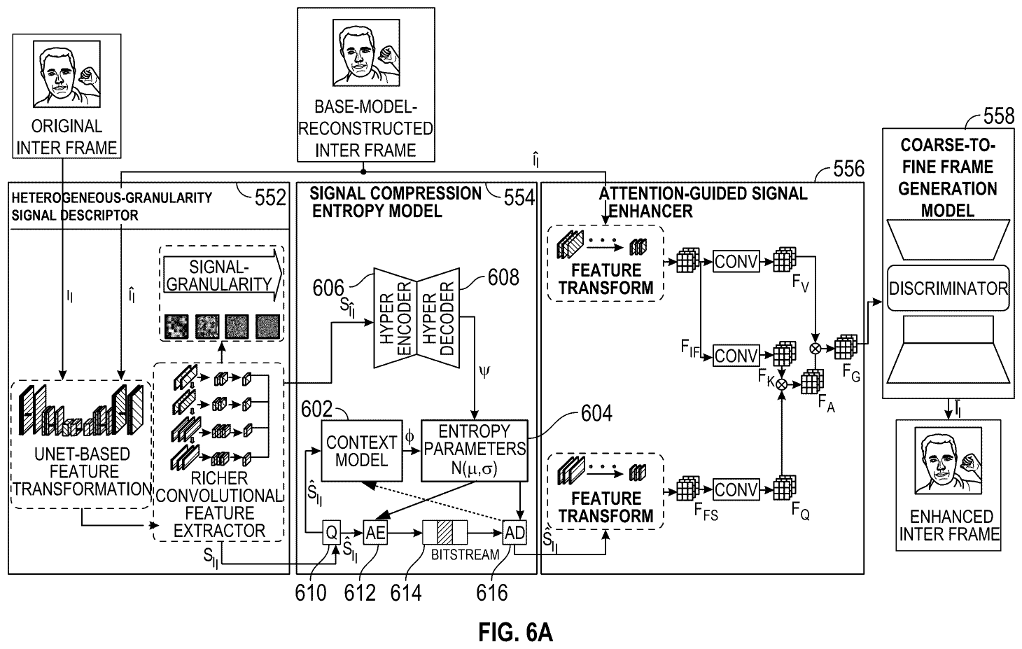

FIG. 5 illustrates a pleno-generation face video compression framework according to example embodiments of the present disclosure. Herein, face frames are represented as latent code (i.e., keypoints, facial semantics and compact feature) and enriched signal (i.e., residual signal, segmentation map and dense flow) based on prior statistics and distributions. A base model 500 implements various GFVC techniques as illustrated in FIGS. 3 and 4 above, such as FOMM, Face_vid2vid, CFTE and the like, while outputs from the base model 500 are input to an enhancement model 550.

According to GFVC techniques, the base model 500 and the enhancement model 550 each includes encoder architecture and decoder architecture. The base model 500 configures one or more processors of a computing system to extract keypoints, facial semantics, compact features), and the extracted information is further compressed and input to a deep generative model. Decoder architecture configured to reconstruct faces based on this input. Outputs from the base model 500, including subsequent inter frames and reconstructed inter frames, are input into the enhancement model 550. These subsequent inter frames may be considered to be a plurality of inter frames, with each subsequent inter frame as an individual inter frame. Based on these inputs, the enhancement model 550, under conditions where high bitstream bandwidth is available for face video communication, enriches facial signals by enhancing reconstructed inter frames. The enhancement model 550 configures one or more processors of a computing system to characterize face data with heterogeneous-granularity facial signals, and selects, for higher or lower bitstream bandwidths, respectively higher-granularity or lower-granularity signals to transmit in a bitstream. Decoder architecture configures one or more processors of a computing system to receive the bitstream and, based on decoded auxiliary facial signals, enhances reconstruction quality of reconstructed frames output from the base model.

FIG. 5 illustrates encoder-architecture of the base model 500, including a block-based encoder 502, an analysis model 504, and a parameter encoder 506. FIG. 5 illustrates decoder-architecture of the base model 500, including a block-based decoder 508, a parameter decoder 510, and a frame synthesis model 512.

A face video sequence includes a key-reference frame K and subsequent inter frames Iₜ(1≤l≤n, l∈Z). The block-based encoder 502 configures one or more processors of a computing system to compress the key-reference frame K (according to block-based video coding standards, such as VVC as illustrated herein), to establish the fundamental texture representation for the reconstruction of successive frames. The compressed key-reference frame is transmitted in a bitstream, and the block-based decoder 508 configures one or more processors of a computing system to reconstruct the decoded key-reference frame. The reconstruction of key-reference frame \hat{K} can be computed according to Equation 1 as follows:

$$\hat{K} = Dec ( Enc ( K ) )$$

where Enc(⋅) and Dec(⋅) represent the encoding and decoding processes of a block-based video coding standard, such as VVC by way of example.

The subsequent inter frames Iₗ are input to the analysis model 504, rather than the block-based encoder 502. The analysis model 504 configures one or more processors of a computing system to extract compact representations F_{comp}^{I}^{ₗ} of multiple inter frames Iₗ, such that motion trajectory variations across multiple inter frames are encode across a sequence of compact representations. As described above with reference to Table 1, a compact representation can be, but is not limited to, learned keypoints extracted by a source keypoint extractor and a driving keypoint extractor of a FOMM; a compact feature matrix extracted by a CFTE feature extractor; facial semantics extracted according to IFVC; and the like. The extraction of

$${F}_{comp}^{{I}_{1}}$$

can be formulated by Equation 2 as follows:

$${F}_{comp}^{{I}_{1}} = φ ( {I}_{1} )$$

where φ(⋅) denotes computations performed as configured by the trained analysis model 504 to evolve prior statistics and distributions of face data into a compact representation (such as, by way of example and without limitation thereto, keypoints, facial semantics and compact feature matrices). By coding face data in a compact fashion, dynamic motion trajectory variations across inter frames are characterized in a compact and latent manner.

A parameter encoder 506 configures one or more processors of a computing system to perform inter predicting, quantizing and entropy coding upon the extracted compact representation

$${F}_{comp}^{{I}_{1}} ,$$

where the coded bits are transmitted into a bitstream. A parameter decoder 510 configures one or more processors of a computing system to, upon receiving a compact representation transmitted in a bitstream, perform inverse quantizing compensation upon the compact representation to reconstruct compact representation

$${\hat{F}}_{comp}^{{I}_{1}} .$$

The frame synthesis model 512 configures one or more processors of a computing system to reconstruct the face video sequence based on the reconstructed compact representation

$${\hat{F}}_{comp}^{{I}_{1}}$$

and the decoded key-reference frame K. The analysis model 504 configures one or more processors of a computing system to project K into the compact representation

$${F}_{comp}^{\hat{K}} ,$$

such that generation of a motion field can be yielded between

$${F}_{comp}^{\hat{K}} and {\hat{F}}_{comp}^{{I}_{1}} .$$

The synthesis of a reconstructed inter frame [symbol] as guided by \hat{K} is described by Equation 3 as follows:

$$= ζ ( \hat{K} , χ ( {\hat{F}}_{comp}^{{I}_{1}} , φ ( \hat{K} ) ) )$$

where x(⋅) and ζ(⋅) represent motion field calculation and frame generation, respectively.

As described above, the base model 550 implements compression of face video at ultra-low bitrates by compact representation. However, quality of reconstructed face video may be undermined by unappealing texture and motion, such as occlusion artifacts, low face fidelity and poor local motion representation.

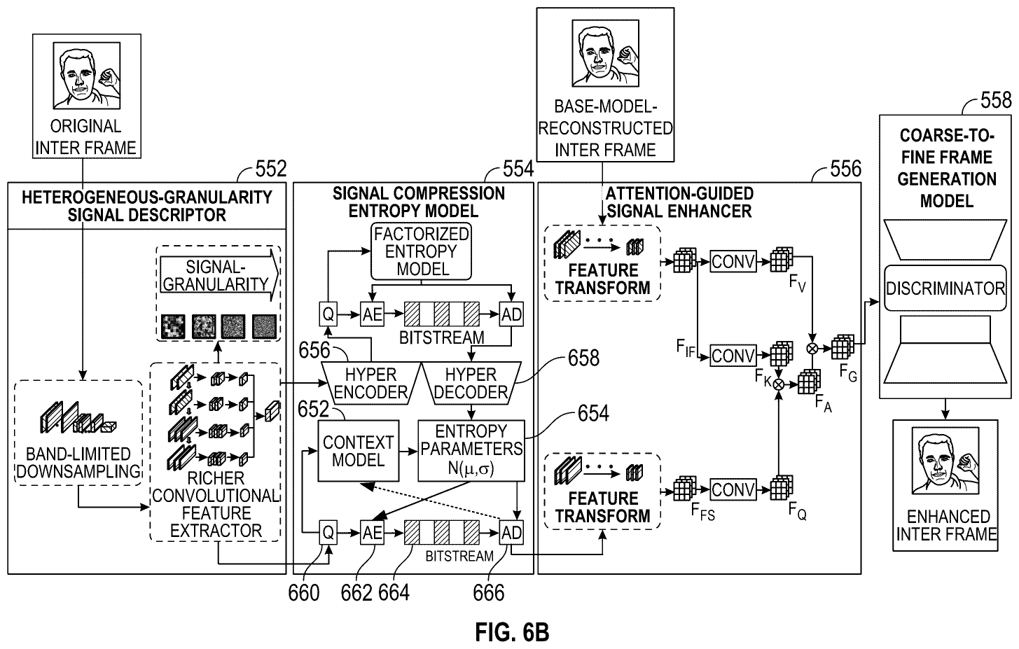

FIGS. 6A and 6B illustrate detailed views of the enhancement model 550 of FIG. 5. A heterogeneous-granularity signal descriptor 552 configures one or more processors of a computing system to perform hierarchical compensation for motion estimation errors according to different bitstream bandwidth environments. A learning-based signal compression entropy model 554 configures one or more processors of a computing system to learn hyperpriors of a probabilistic model for coding of an auxiliary facial signal. An attention-guided signal enhancer 556 and a coarse-to-fine frame generation model 558 configure one or more processors of a computing system to reconstruct a face video for display based on the base model face frames and the reconstructed facial signals.

Q, AE, AD and Conv denote the quantization, arithmetic encoding, arithmetic decoding and convolution processes, respectively.

To implement auxiliary facial signal processing, the heterogeneous-granularity signal descriptor 552 configures one or more processors of a computing system to input subsequent (original) inter frames Iₗ to a band-limited downsampler using an anti-aliasing mechanism and padding/convolution operations, which can better preserve the input signal when downsampling. The heterogeneous-granularity signal descriptor 552 configures one or more processors of a computing system to input subsequent inter frames to a UNet-like network to actualize the transformation from the input face image to a high-dimensional face feature map. In addition, the heterogeneous-granularity signal descriptor 552 configures one or more processors of a computing system to perform richer convolutional architecture and Generalized Divisive Normalization (“GDN”) operations upon multi-level information and parametric nonlinear transformation from the high-dimensional face feature map, such that these extracted features can be further combined in a holistic manner and better compensate the information loss of compact representations. The process can follow Equation 4 below:

$${S}_{{I}_{1}} = {g}_{( conv , GDN )} ( {f}_{UNet} ( v ( {I}_{1} , s ) ) )$$

where v(⋅), f_{UNet}(⋅) and g_{(conv,GDN)}(⋅) denote signal down-sampling, high-dimensional feature learning and multi-level feature extraction processes, respectively. s is the scale factor to determine the spatial size of face image. The heterogeneous-granularity signal descriptor 552 configures one or more processors of a computing system to select a signal granularity of an original auxiliary facial signal S_{I}_{ₗ}; a higher or lower granularity of the original auxiliary facial signal S_{I}_{ₗ} can be selected randomly or selected according to respectively higher or lower bitstream bandwidths. A selected granularity can be, by way of example but without limitation thereto, 64×64×1, 48×48×1, 32×32×1, 32×32×1, 24×24×1, 16×16×1, or 8×8×1.

Example embodiments of the present disclosure implement high-efficiency compression of heterogeneous-granularity feature representation by two mechanisms based on the above feature extraction.

According to example embodiments of the present disclosure, a model-generated auxiliary facial signal [symbol] from a base-model-reconstructed inter frame [symbol] is a hyperprior for a probabilistic model. Based on this probabilistic structure, fully factorized priors are optimized to achieve high-efficiency compression of an original auxiliary facial signal S_{I}_{ₗ}.

The signal compression entropy model 554 of FIG. 6A, trained for compression of a heterogeneous-granularity auxiliary signal, includes a context model 602 (an autoregressive model over latents), and a hyper-network (hyper-encoder 606 and hyper-decoder 608) for [symbol] . Hyperpriors of a probabilistic model are learned for entropy coding of the auxiliary facial signal S_{I}_{ₗ}, which can correct context-based predictions and reduce coding bits.

The signal compression entropy model 554 configures one or more processors of a computing system to input S_{I}_{ₗ} to quantizer 610 (“Q”), then input the quantized auxiliary facial signal [symbol] to arithmetic encoder 612 (“AE”) to produce the coded bitstream 614. The arithmetic decoder (“AD”) 616 configures one or more processors of a computing system to decode the coded bitstream 614 to yield a reconstructed auxiliary facial signal [symbol] . To improve compression performance, a Gaussian distribution 604, represented by entropy parameters μ and σ, is additionally introduced based on outputs of the context model 602 and the hyper-network, to assist decoding. The hyperprior ψ can be predicted from the heterogeneous-granularity signal from key-reference frame S_{K} without any entropy coding via the hyper-network Nₕₚ(⋅) and learned parameters θₕₚ according to Equation 5 as follows:

$$ψ = {N}_{hp} ( {S}_{K} ; {θ}_{hp} )$$

In addition, the causal context ¢ of quantized auxiliary facial signal [symbol] can be obtained via the context model 602 N_{cm}(⋅) and its learned parameters θ_{cm} according to Equation 6 as follows:

$$ϕ = {N}_{cn} ( ; {θ}_{cm} )$$

The mean and scale parameters μ and σ can be further conditioned on both the hyperprior ψ as well as the causal context ϕ, which is represented according to Equation 7 as follows:

$$μ , σ = {N}_{ep} ( ψ , ϕ ; {θ}_{ep} )$$

where θₑₚ is a function to learn entropy parameters.

Finally, the learned Gaussian distribution is input to the AD 616, and the AD 616 configures one or more processors of a computing system to predict, based on the learned Gaussian distribution, the reconstructed auxiliary facial signal [symbol] according to Equation 8 as follows.

$$( \hat{{S}_{{I}_{1}}} \vert {θ}_{hp} , {θ}_{cm} , {θ}_{ep} ) = ( 𝒩 ( μ , {σ}^{2} ) * 𝒰 ( - \frac{1}{2} , \frac{1}{2} ) ) ( )$$

The signal compression entropy model 554 of FIG. 6B is trained to perform compression of an original auxiliary facial signal given, as input, original auxiliary facial signals of heterogeneous granularities as described above. The signal compression entropy model 554 includes a context model 652 (an autoregressive model over latents), and a hyper-network (hyper-encoder 656 and hyper-decoder 658) for [symbol] . An entropy model 554 is trained with joint autoregressive and hierarchical priors to perform high-efficiency compression of the original auxiliary facial signal S_{I}_{ₗ} The model-generated auxiliary facial signal [symbol] from the base-model-reconstructed inter frame [symbol] is employed to achieve signal-level reduction with the original auxiliary facial signal Sy via signal difference according to Equation 9 as follows:

$${Diff}_{res} = - {S}_{{I}_{1}}$$

The signal compression entropy model 554 configures one or more processors of a computing system to input Diffᵣₑₛ to quantizer 660 and arithmetic encoder 662 to produce the coded bitstream 664. The arithmetic decoder (“AD”) 666 configures one or more processors of a computing system to decode the coded bitstream 664 to reconstruct the signal. To improve the compression performance, a Gaussian distribution 654, represented by entropy parameters μ and σ, is additionally introduced based on outputs of the context model 652 and the hyper-network, to assist decoding.

More specifically, the variance σ of the Gaussian distribution is also stored in the coded bitstream 664 via the hyper-encoder 656, quantizer 660 and arithmetic encoder 662. After that, the stored variance σ can be reconstructed through the arithmetic decoder 666 and hyper-decoder 658 when decoding the bitstream 664. On the other hand, the context model can facilitate the reconstruction of the mean value μ, such that σ and μ are further combined to simulate the Gaussian distribution. The arithmetic decoder 666 configures one or more processors of a computing system to compute a reconstructed auxiliary facial signal [symbol] based on the decoded [symbol] and the Gaussian distribution as described by the entropy parameters μ and σ.

The attention-guided signal enhancer 556 of FIGS. 6A and 6B configures one or more processors of a computing system to boost the generation quality of the base-model-reconstructed face [symbol] based on the reconstructed auxiliary facial signal [symbol] , compensating for motion estimation error and preserve facial structure and background information. The reconstructed face frame [symbol] from the base model is first transformed into facial features F_{if}. The signal features F_{fs} with the same feature dimension of F_{if} are obtained by transforming the auxiliary facial signal [symbol] . Three different convolution layers configure one or more processors of a computing system to perform linear projection operations upon F_{if} and F_{fs}, F_{if} yielding the corresponding latent feature maps Fᵥ and Fₖ, and F_{fs} yielding the latent feature map F_{q}, these feature maps respectively representing value, key and query applied in self-attention.

Attention layers according to implementations of transformer learning models configure transformation operations upon tokens input at the attention layer to compute self-attention among the tokens. The transformation operations may output a query matrix, a key matrix, and a value matrix, applied in matrix operations so that values of tokens are adjusted by values of other tokens by self-attention.

In accordance with Equation 10, Equation 11, and Equation 12 as follows:

$${F}_{v} = {Conv}_{v} ( {Φ}_{I} ( \hat{{I}_{1}} ) )$$

$${F}_{k} = {Conv}_{k} ( {Φ}_{I} ( \hat{{I}_{1}} ) )$$

$${F}_{q} = {Conv}_{q} ( {Φ}_{S} ( \hat{{S}_{{I}_{1}}} ) )$$

where Φ_{I} and Φ_{S} represent the feature transformation processes of [symbol] and [symbol] via the deep neural networks, respectively, Convᵥ, Convₖ and Conv_{q} denote three different convolutional layers with kernels wᵥ, wₖ and w_{q}.

The obtained query feature F_{q} projected from auxiliary signal feature F_{fs} is further fused with key feature Fₖ to yield fused feature Fₐ to compensate for motion estimation errors and guide face frame generation. The fused feature Fₐ is further fused with the value feature Fᵥ to yield the final attention feature F_{q} for face generation, formulated by Equation 13 as follows:

$${F}_{g} = {F}_{a} \times {F}_{v} = Softmax ( {F}_{q} , {( {F}_{k} )}^{T} ) \times {F}_{v}$$

where Softmax(⋅) is a softmax normalization function.

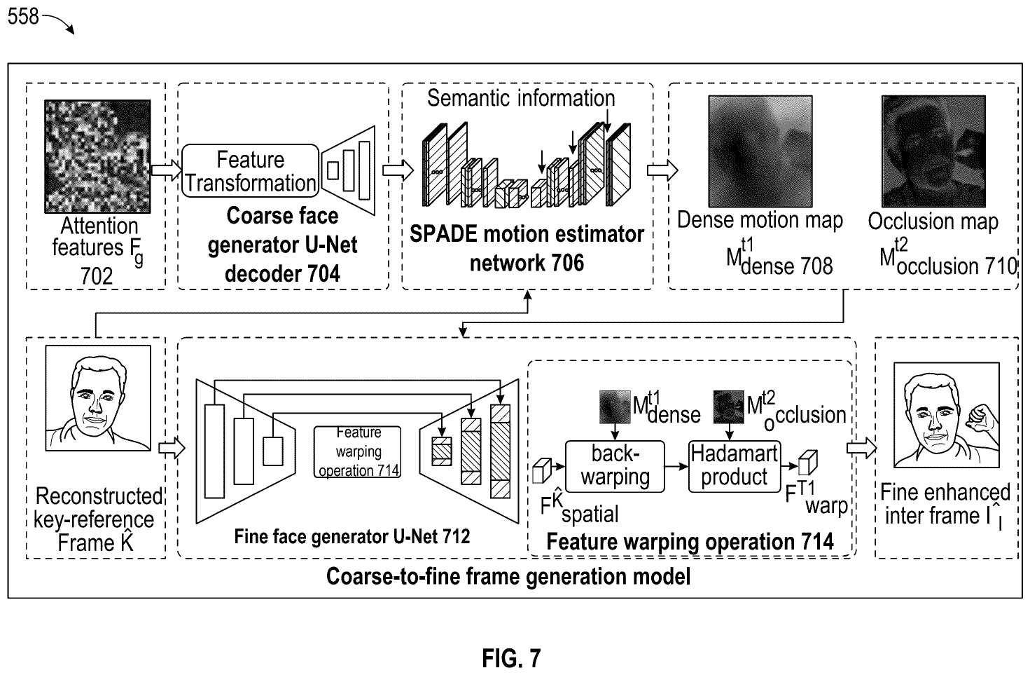

FIG. 7 illustrates the coarse-to-fine frame generation model 558 of FIGS. 5, 6A, and 6B. Herein, a generative adversarial network is trained to reconstruct high-fidelity face results, including a generator and a discriminator. The generator and the discriminator are each a trained learning model.

The generator is trained based on captured data and extracted features to generate synthetic data which incorporates synthetic face features. Based on captured facial images and facial features extracted therefrom, the generator generates synthetic data which utilizes context of facial features (such as features related to physical characteristics, features related to behavioral characteristics such as expressions, contextual information such as lighting, skin color, wrinkles and the like, and labeled identities) to generate synthetic facial images.

The discriminator is trained based on real data and synthetic data to learn to discriminate synthetic data from real data. Based thereon, the discriminator can feed output back to the generator to train the generator to improve synthesis of images.

As illustrated in FIGS. 6A and 6B, the attention features F_{g} 702 from the attention-guided signal enhancer 556 are input to a coarse face generator U-Net decoder 704, and the coarse face generator U-Net decoder 704 configures one or more processors of a computing system to output coarsely enhanced inter frames [symbol] that have accurate motion information but lossy texture reference, in accordance with Equation 14 as follows:

$$\tilde{{I}_{l}} = {G}_{frame} ( {F}_{g} )$$

where G_{frame}(⋅) is the subsequent network layers of U-Net.

Coarse-to-fine generation prevents mixing of attention features F_{g} 702 with inaccurate base model texture representation, to ensure that the final generation result has high-quality texture reference without error accumulation. The reconstructed key-reference frame \hat{K} and the coarse-generated inter frame [symbol] are concatenated into a Spatially-Adaptive Normalization (“SPADE”) motion estimator network 706 (i.e., S_{PADE}(⋅)) to preserve semantic information and learn a motion estimation field (i.e., dense motion map

$${ℳ}_{dense}^{{I}_{l}}$$

and facial occlusion map

$${ℳ}_{occlusion}^{{I}_{l}}$$

710) therefrom, in accordance with Equation 15 and Equation 16 as follows:

$${ℳ}_{dense}^{{I}_{l}} = {P}_{1} ( {S}_{P A D E} ( concat ( \hat{K} , \tilde{{I}_{1}} ) ) )$$

$${ℳ}_{occlusion}^{{I}_{l}} = {P}_{2} ( {S}_{P A D E} ( concat ( \hat{K} , \tilde{{I}_{1}} ) ) )$$

where P₁(⋅) and P₂(⋅) indicate two different predicted outputs, and concat(⋅) denotes the concatenation operation.

After obtaining explicit motion information, a multi-scale GAN module is further utilized for realistic talking face reconstruction. An encoder of a fine face generator U-Net 712 configures one or more processors of a computing system to transform the block-based reconstructed key-reference frame \hat{K} into multi-scale spatial features

$${F}_{spatial}^{\hat{K}} .$$

Then, the dense motion field

$${ℳ}_{dense}^{{I}_{l}}$$

708 and the facial occlusion map

$${ℳ}_{occlusion}^{{I}_{l}}$$

710 are applied the multi-scale spatial features

$${F}_{spatial}^{\hat{K}}$$

to perform a feature warping operation 714 (illustrated enlarged inset) for obtaining multi-scale transformed feature F_{warp}, in accordance with Equation 17 as follows:

$${F}_{warp}^{{I}_{1}} = {ℳ}_{occlusion}^{{I}_{l}} ⊙ {f}_{w} ( {F}_{spatial}^{\hat{K}} , {ℳ}_{dense}^{{I}_{l}} )$$

where ⊙ and f_{w}(⋅) represent the Hadamard operation and feature warping process, respectively.

These multi-scale warped features F_{warp} is input to the U-Net decoder to reconstruct high-quality and high-fidelity face in accordance with Equation 18 as follows:

$$\vec{{I}_{1}} = {G}_{frame} ( {F}_{warp}^{{I}_{1}} )$$

The discriminator guarantees that \vec{Iₗ} can be reconstructed towards a realistic image with the supervision of ground-truth image Iₗ.

Self-supervised training is performed during training of respective models of FIGS. 6A and 6B to optimize the heterogeneous-granularity signal descriptor, entropy model, attention-guided signal enhancer, and frame generation model. The corresponding loss objectives in the model training include, but are not limited to, perceptual loss, adversarial loss, identity loss and rate-distortion loss.

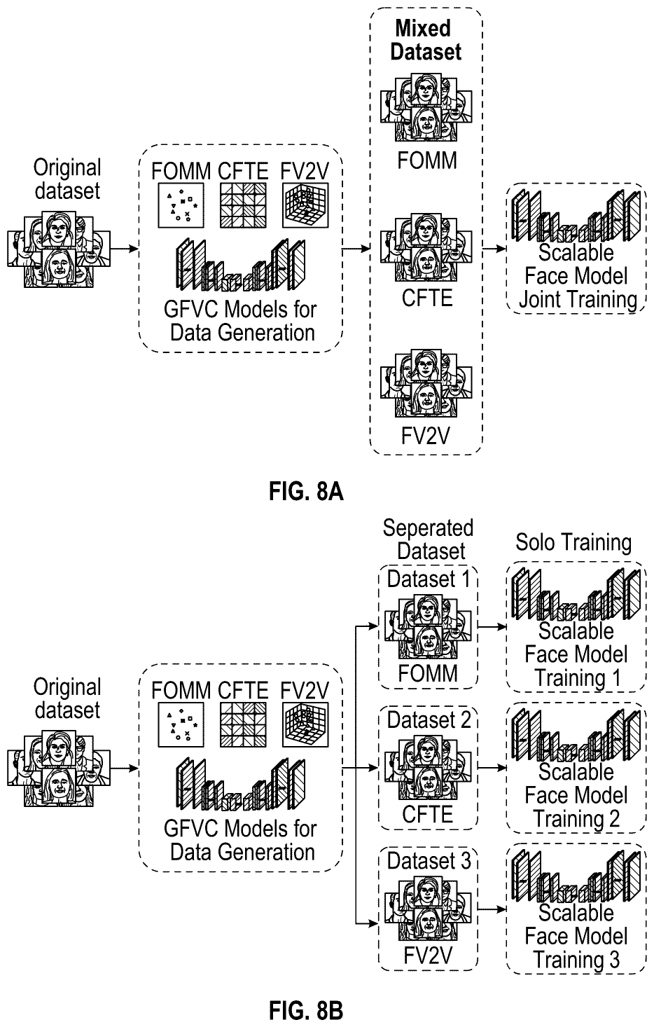

FIGS. 8A and 8B illustrate flowcharts of two different training strategies: mixed-model dataset generation and training, and model-specific dataset generation and training.

As discussed above, a base model 500 can be implemented according to GFVC models like FOMM, CFTE, and FV2V. Existing GFVC models are run to generate training datasets of reconstructed face videos. FIG. 8A illustrates generating a mixed-model video training dataset input to train a unified scalable face enhancement model, interoperable with heterogeneously implemented base models based on different GFVC models. FIG. 8B illustrates generating model-specific datasets of reconstructed face videos from different respective GFVC models, which are input to train different model-specific scalable face enhancement models; each trained enhancement model is only adaptable to a base model implemented according to a corresponding GFVC model.

By adopting a pleno-generation framework as described herein, face data is characterized with compact representation and enriched signal, available for auxiliary transmission in high-bandwidth applications. Conceptually-explicit visual information in a segmentable and interpretable bitstream can be partially transmitted and decoded to implement different-layer visual reconstruction at different quality levels, under both low-bandwidth and high-bandwidth conditions.

The disclosed pleno-generation framework can outperform reconstruction quality limitations of the existing GFVC algorithms, such as occlusion artifacts, low face fidelity, and poor local motion. Under guidance of auxiliary visual signals, motion estimation errors from compact representation can be perceptually compensated and long-term dependencies among face frames can be accurately regularized. As a consequence, the enhancement model output can greatly improve the reconstruction quality, faithfully representing texture and motion at pixel-level reconstruction.

Furthermore, the disclosed pleno-generation framework provides scalability by segmenting the enhancement model from the base model. The base model can be implemented according to various different GFVC implementations, and the same enhancement model is compatible and interoperable with each possible implementation of the base model. In addition to flexible interoperability, the enhancement model itself implements heterogeneous-granularity signal representations and support different-quality face video communication under both low-bandwidth and high-bandwidth conditions.

FIG. 9 illustrates an example system 900 for implementing the processes and methods described above for implementing a pleno-generation face video compression framework with bandwidth intelligence for generative models and compression.

The techniques and mechanisms described herein may be implemented by multiple instances of the system 900 as well as by any other computing device, system, and/or environment. The system 900 shown in FIG. 9 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 900 may include one or more processors 902 and system memory 904 communicatively coupled to the processor(s) 902. The processor(s) 902 may execute one or more modules and/or processes to cause the processor(s) 902 to perform a variety of functions. In some embodiments, the processor(s) 902 may include a central processing unit (“CPU”), a graphics processing unit (“GPU”), both CPU and GPU, or other processing units or components known in the art. Additionally, each of the processor(s) 902 may possess its own local memory, which also may store program modules, program data, and/or one or more operating systems.

Depending on the exact configuration and type of the system 900, the system memory 904 may be volatile, such as RAM, non-volatile, such as ROM, flash memory, miniature hard drive, memory card, and the like, or some combination thereof. The system memory 904 may include one or more computer-executable modules 906 that are executable by the processor(s) 902.

The modules 906 may include, but are not limited to, one or more of a block-based encoder 908, a block-based decoder 910, an analysis model 912, a parameter encoder 914, a parameter decoder 916, a heterogeneous-granularity signal descriptor 918, an entropy model 920, an attention-guided signal enhancer 922, a coarse-to-fine frame generation model 924, and a neural network trainer 926.

The block-based encoder 908 configures the processor(s) 902 to perform block-based coding by techniques and processes described above, such as an encoding process 100 of FIG. 1.

The block-based decoder 910 configures the processor(s) 902 to perform block-based coding by techniques and processes described above, such as a decoding process of FIG. 1.

The analysis model 912 configures the processor(s) 902 to perform picture coding by techniques and processes described above, such as outputting a compact representation as described above with reference to FIG. 5.

The parameter encoder 914 configures the processor(s) 902 to perform picture coding by techniques and processes described above, such as encoding a compact representation as described above with reference to FIG. 5.

The parameter decoder 916 configures the processor(s) 902 to perform picture coding by techniques and processes described above, such as decoding a compact representation as described above with reference to FIG. 5.

The heterogeneous-granularity signal descriptor 918 configures the processor(s) 902 to perform picture coding by techniques and processes according to example embodiments of the present disclosure, such as hierarchical compensation for motion estimation errors as described above with reference to FIG. 5.

The entropy model 920 configures the processor(s) 902 to perform picture coding by techniques and processes according to example embodiments of the present disclosure, such as reconstructing a reconstructed subsequent picture as described above with reference to FIG. 5.

The attention-guided signal enhancer 922 configures the processor(s) 902 to perform picture coding by techniques and processes according to example embodiments of the present disclosure as described above with reference to FIGS. 6A and 6B.

The coarse-to-fine frame generation model 924 configures the processor(s) 902 to perform picture coding by techniques and processes according to example embodiments of the present disclosure as described above with reference to FIG. 7.

The neural network trainer 926 configures the processor(s) 902 to train any learning model as described herein, such as an analysis model 912, a heterogeneous-granularity signal descriptor 918, an entropy model 920, an attention-guided face enhancer 922, or a coarse-to-fine frame generation model 924.

The system 900 may additionally include an input/output (“I/O”) interface 940 for receiving image source data and bitstream data, and for outputting reconstructed frames into a reference frame buffer and/or a display buffer. The system 900 may also include a communication module 950 allowing the system 900 to communicate with other devices (not shown) over a network (not shown). The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. It should be noted that while the exemplary embodiments and/or figures may describe an associated system, the example components of the computing device(s) may be distributed.

Other architectures may be used to implement the described functionality and are intended to be within the scope of this disclosure. Although specific distributions of responsibilities are defined above for purposes of discussion, the various functions and responsibilities might be distributed and divided in different ways, depending on circumstances. Further, aspects of the various processes and frameworks can be performed on any of the devices discussed herein.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

Operations and features of the techniques discussed herein may be performed by one or more computing devices. The computing device(s) may comprise a system including one or multiple components, some of which may be or may include one or more non-transitory computer-readable media which may cause processors to perform operations when executed. The components may, in other examples, be software, computational modules, specifically-developed computational algorithms, or trained machine-learned models. The components may, in other examples, be computing devices, processing units, or processors. By way of example and not limitation, the components may comprise one or more Central Processing Units (CPUs), Graphics Processing Units (GPUs), or any other device or portion of a device that processes electronic data to transform that electronic data into other electronic data that may be stored in registers and/or computer readable media. In some examples, integrated circuits (e.g., ASICs), gate arrays (e.g., FPGAs), and other hardware devices can also be considered processors insofar as they are configured to implement encoded instructions. The components may operate independently, in serial, or in parallel. In other examples, components and/or computing devices may be specifically printed chips optimized to perform the techniques disclosed herein, or logic circuits which perform the techniques herein based on instructions that may be encoded in software, hardware, or a combination of the two.

In some examples, multiple models or configurations of models may be used. The techniques may apply the multiple models in order, may apply various models to various portions of data, or may include an evaluation and determination not to use certain configurations of models made available in certain circumstances. In some examples, various implementations and/or associated metrics may be compared to determine a tailored and/or tuned implementation. In some examples, there may be a priority associated with implementations. The selection of the model and/or implementation may be performed by a user, by one or more specifically-developed computation algorithms, by a licensed entity associated with the bitstream, by a regulatory entity, by a third party, by one or more trained machine-learned models, or any combination thereof.

Suitable computing devices for the operations of features herein may include, by way of example and not limitation, personal communication devices, cell phones, laptop computers, tablet computers, monitor displays, desktop computers, personal digital assistants, smart wearable devices, internet of things (“IoT”) devices, minicomputers, mainframe computers, robot mounted computers, data cables, data connections, databases, security devices, cameras, video projectors, televisions, video management hubs, digital billboards, central computing systems, central communication management interfaces, communication switch-level management interfaces, automated energy purchasing interfaces, robot sensors, etc. The computing devices may comprise components associated with audio/video applications enabling display, running, processing, or associated operations for audio/video (such as TV series, movies, variety shows, music, etc.). The devices, components, and/or applications may also be associated with operations of a user or associated entity, such as providing feedback, implementing content controls, gathering interaction data, interactive controls associated with the video, extracting information (such as parsing speech or events), determining play rate, playing designated portions of the video (such as skipping to a portion), displaying buffering process, associating or retrieving metadata, etc. The video may be locally stored, transmitted via a communication, etc.

Generally, many of the considerations and features discussed with respect to one layer may additionally apply to other layer(s), as well as vice versa. The layers may be, in part or in whole, interoperable, independent, parallel, sequential, dependent, etc. The layers may be operated by the same entity, different entities, or a combination thereof.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient or non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), synchronous dynamic RAM (“SDRAM”), other types of random-access memory (“RAM”), read-only memory (“ROM”), electrically erasable programmable read-only memory (“EEPROM”), non-volatile/flash-type memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. The architectures, systems, and individual elements described herein may include many other logical, programmatic, and physical components, of which those discussed herein are merely examples that are related to the discussion of the disclosed techniques. As can be understood, the features discussed herein are described as divided for exemplary purposes. However, the operations performed by the various features may be combined or performed by other features. Control, communication, intra- and inter-layer/model/framework transmission, and/or received data may be performed digitally, physically, by signal, by sensor, by other modalities, and/or any combination thereof.

A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

The computer-readable instructions stored on one or more non-transient or non-transitory computer-readable storage media that, when executed by one or more processors, may perform operations described above with reference to FIGS. 1-8B. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

1. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
reconstructing a plurality of reconstructed inter frames of a video sequence by inputting a plurality of original inter frames to a generative face video compression (“GFVC”) model;
extracting an original auxiliary facial signal from the plurality of original inter frames;
extracting a model-generated auxiliary facial signal from the plurality of reconstructed inter frames;
predicting a reconstructed auxiliary facial signal from a quantized auxiliary facial signal, based on a difference between the model-generated auxiliary facial signal and the original auxiliary facial signal; and
boosting generation quality of the reconstructed inter frames based on the reconstructed auxiliary facial signal.

2. The computing system of claim 1, wherein extracting the original auxiliary facial signal from the plurality of original inter frames comprises:
downsampling the plurality of original inter frames; and
transforming the plurality of original inter frames to a high-dimensional face feature map; and extracting a model-generated auxiliary facial signal from the plurality of reconstructed inter frames comprises:
downsampling the plurality of reconstructed inter frames; and
transforming the plurality of reconstructed inter frames to a high-dimensional face feature map.

3. The computing system of claim 1, wherein extracting a model-generated auxiliary facial signal from the plurality of reconstructed inter frames comprises:
selecting a higher or lower granularity of the original auxiliary facial signal based on higher or lower bitstream bandwidth.

4. The computing system of claim 1, wherein the reconstructed auxiliary facial signal is predicted based further on a Gaussian distribution comprising entropy parameters.

5. The computing system of claim 4, wherein the entropy parameters are conditioned upon:
a hyperprior comprising the model-generated auxiliary facial signal; and
a causal context of the quantized auxiliary facial signal.

6. The computing system of claim 1, wherein boosting generation quality of the reconstructed inter frames based on the reconstructed auxiliary facial signal comprises:
transforming the reconstructed inter frames into facial features;
transforming the reconstructed auxiliary facial signal into signal features having a same feature dimensionality as the facial features;
performing linear projection upon the facial features and the signal features to yield latent feature maps; and
inputting the latent feature maps into an attention layer to yield fused attention features.

7. The computing system of claim 6, wherein boosting generation quality of the reconstructed inter frames based on the reconstructed auxiliary facial signal further comprises:
inputting the attention features to a coarse face generator U-Net decoder to yield coarsely enhanced inter frames;
learning a motion estimation field and a facial occlusion map by concatenating a reconstructed key-reference frame and the coarsely enhanced inter frames; and
applying the motion estimation field and the facial occlusion map to multi-scale spatial features derived from the reconstructed key-reference frame.

8. A method, comprising:
reconstructing a plurality of reconstructed inter frames of a video sequence by inputting a plurality of original inter frames to a generative face video compression (“GFVC”) model;
extracting an original auxiliary facial signal from the plurality of original inter frames;
extracting a model-generated auxiliary facial signal from the plurality of reconstructed inter frames;
predicting a reconstructed auxiliary facial signal based on a difference between the model-generated auxiliary facial signal and the original auxiliary facial signal; and boosting generation quality of the reconstructed inter frames based on the reconstructed auxiliary facial signal.

9. The method of claim 8, wherein extracting the original auxiliary facial signal from the plurality of original inter frames comprises:
downsampling the plurality of original inter frames; and
transforming the plurality of original inter frames to a high-dimensional face feature map; and extracting a model-generated auxiliary facial signal from the plurality of reconstructed inter frames comprises:
downsampling the plurality of reconstructed inter frames; and
transforming the plurality of reconstructed inter frames to a high-dimensional face feature map.

10. The method of claim 8, wherein extracting a model-generated auxiliary facial signal from the plurality of reconstructed inter frames comprises:
selecting a higher or lower granularity of the original auxiliary facial signal based on higher or lower bitstream bandwidth.

11. The method of claim 8, wherein the reconstructed auxiliary facial signal is predicted based further on a Gaussian distribution comprising entropy parameters.

12. The method of claim 11, wherein the entropy parameters are conditioned upon:
a hyperprior comprising the model-generated auxiliary facial signal; and
a causal context of the quantized auxiliary facial signal.

13. The method of claim 8, wherein boosting generation quality of the reconstructed inter frames based on the reconstructed auxiliary facial signal comprises:
transforming the reconstructed inter frames into facial features;
transforming the reconstructed auxiliary facial signal into signal features having a same feature dimensionality as the facial features;
performing linear projection upon the facial features and the signal features to yield latent feature maps; and
inputting the latent feature maps into an attention layer to yield fused attention features.

14. The method of claim 13, wherein boosting generation quality of the reconstructed inter frames based on the reconstructed auxiliary facial signal further comprises:
inputting the attention features to a coarse face generator U-Net decoder to yield coarsely enhanced inter frames;
learning a motion estimation field and a facial occlusion map by concatenating a reconstructed key-reference frame and the coarsely enhanced inter frames; and
applying the motion estimation field and the facial occlusion map to multi-scale spatial features derived from the reconstructed key-reference frame.

15. One or more non-transitory computer-readable media storing instructions that, when executed, cause one or more processors to perform operations comprising:
reconstructing a plurality of reconstructed inter frames of a video sequence by inputting a plurality of original inter frames to a generative face video compression (“GFVC”) model;
extracting an original auxiliary facial signal from the plurality of original inter frames;
extracting a model-generated auxiliary facial signal from the plurality of reconstructed inter frames;
predicting a reconstructed auxiliary facial signal based on a difference between the model-generated auxiliary facial signal and the original auxiliary facial signal; and
boosting generation quality of the reconstructed inter frames based on the reconstructed auxiliary facial signal.

16. The non-transitory computer-readable media of claim 15, wherein extracting the original auxiliary facial signal from the plurality of original inter frames comprises:
downsampling the plurality of original inter frames; and
transforming the plurality of original inter frames to a high-dimensional face feature map; and extracting a model-generated auxiliary facial signal from the plurality of reconstructed inter frames comprises:
downsampling the plurality of reconstructed inter frames; and
transforming the plurality of reconstructed inter frames to a high-dimensional face feature map.

17. The non-transitory computer-readable media of claim 15, wherein extracting a model-generated auxiliary facial signal from the plurality of reconstructed inter frames comprises:
selecting a higher or lower granularity of the original auxiliary facial signal based on higher or lower bitstream bandwidth.

18. The non-transitory computer-readable media of claim 15, wherein the reconstructed auxiliary facial signal is predicted based further on a Gaussian distribution comprising entropy parameters.

19. The non-transitory computer-readable media of claim 15, wherein boosting generation quality of the reconstructed inter frames based on the reconstructed auxiliary facial signal comprises:
transforming the reconstructed inter frames into facial features;
transforming the reconstructed auxiliary facial signal into signal features having a same feature dimensionality as the facial features;
performing linear projection upon the facial features and the signal features to yield latent feature maps; and
inputting the latent feature maps into an attention layer to yield fused attention features.

20. The non-transitory computer-readable media of claim 19, wherein boosting generation quality of the reconstructed inter frames based on the reconstructed auxiliary facial signal further comprises:
inputting the attention features to a coarse face generator U-Net decoder to yield coarsely enhanced inter frames;
learning a motion estimation field and a facial occlusion map by concatenating a reconstructed key-reference frame and the coarsely enhanced inter frames; and
applying the motion estimation field and the facial occlusion map to multi-scale spatial features derived from the reconstructed key-reference frame.
